(19) United States
(12) Patent Application Publication
(10) Pub. No.: US 2025/0280765 A1
(43) Pub. Date: Sep. 11, 2025

(54) Concave Arrangement of a Combine Harvester

(71) Applicant: AGCO do Brasil Soluções Agrícolas Ltda., Ribeirao Preto (BR)

(72) Inventor: Marcelo Carpenedo, Sapucaia do Sul (BR)

(21) Appl. No.: 19/069,654

(22) Filed: Mar. 4, 2025

(30) Foreign Application Priority Data
Mar. 6, 2024 (GB) 2403251.8

(51) Int. Cl. A01F 12/26; A01F 12/28

(52) U.S. Cl. CPC A01F 12/26; A01F 12/28

(57) ABSTRACT

A concave arrangement for a combine harvester has a frame which supports a set of side-by-side concave sections, each supported by a pair of support arms of the frame. A roller arrangement is provided between each concave section and each of the pair of support arms such that each concave section is slidable around the frame along an arcuate path between installed and retracted positions. The concave sections can be fixed to the frame in their installed positions.

### CROSS-REFERENCE TO RELATED APPLICATIONS

This application claims the benefit of the filing date of U. K. Provisional Patent Application 2403251.8, “A Concave Arrangement of a Combine Harvester,” filed Mar. 6, 2024, the entire disclosure of which is incorporated herein by reference.

### FIELD

Embodiments of the present disclosure relate generally to combine harvesters, and in particular to the concave of a threshing or separating system of the combine harvester.

### BACKGROUND

A combine harvester typically includes a crop cutting head (header) and a threshing system for detaching grains of cereal from the ears of cereal. A delivery system, known as the feederhouse, delivers the cut crop to the threshing system. The threshing system is for detaching grains of cereal from the ears of cereal. A separating apparatus is downstream of the threshing system, and a grain cleaning apparatus receives grain from the separating apparatus.

The header is typically in the form of a wide array of cutters and a delivery auger (or belt) to feed the cut material to the central feederhouse. The feederhouse is typically in the form of a conveyor chain with cross bars that transport the crop material.

There are various designs for the threshing system and for the separating apparatus (e.g. axial or transverse) as well as for the grain cleaning apparatus. However, in all designs, there is a flow of material from the threshing system to the separating apparatus, and between the separating apparatus and the grain cleaning unit, in particular from a stratification pan to the grain cleaning unit.

The threshing system typically comprises threshing rotors that rotate with respect to concave gratings (known simply as “concaves”). As mentioned above, the threshing rotors may be arranged transversally or longitudinally with respect to the direction of travel of the combine harvester.

The most traditional threshing systems is the transverse threshing system, commonly called “conventional” threshing, where the rotor combined with its static concave is placed transversally to the machine, receiving all the material coming from the feeding system in a perpendicular flow. This allows the material to be processed without the need for a change in direction. In terms of maintenance, this system has some limitations specially regarding the access to the concaves. The concaves are commonly accessed by the frontal machine area, and this access needs the feederhouse to be disassembled to have access to the parts.

The distance between the concave and the rotor is typically adjustable, so that the threshing system may be configured for different crop types and harvesting conditions. A safety mechanism is also used to protect the combine when dense swathes of crops or large rigid objects enter the machine, such as stones or pieces of metal or wood or just wet clumps of crop material.

In addition to the adjustability described above, concaves are preferably designed according the type of grains being processed, where each type of grain (corn, rice, beans and fine grains) has its own design to enable a proper threshing process. This means the combine harvester needs to be set up, by swapping over the concaves, according the crop to be harvested.

The concaves are usually heavy parts due the structure needed to support the threshing loads, resulting in components that are not easy to handle. Furthermore, currently the entire concave needs to be removed to change the crop type. Debris accumulation around the concaves also makes this maintenance and setup function difficult, with extra force needed to move the parts.

It is known to segment the concaves in order to reduce the force necessary to move the parts. However, it can remain challenging to physically move the concave segments into place and to remove them.

### BRIEF SUMMARY

The invention is defined by the claims. According to examples in accordance with this disclosure, there is provided a concave arrangement for a combine harvester, comprising:
a frame comprising at least three arcuate support arms arranged parallel to each other in a row;
a set of at least two concave sections for positioning side-by-side along an axial direction of the concave arrangement, each concave section for positioning between a respective adjacent pair of support arms, supported by those support arms,
wherein the concave arrangement comprises a roller arrangement between each concave section and each of the adjacent pair of support arms such that each concave section is slidable around the frame along an arcuate path between installed and retracted positions,
and wherein the concave arrangement comprises a fixing for fixing the concave sections to the frame in their installed positions.

This concave design enables the concave to be swapped over in sections, and each section runs on rollers for easy removal and replacement. The concave sections are inserted and removed along an arcuate path, in particular in a generally circumferential direction. It is noted that “radial” and “circumferential” refer to the generally cylindrical shape of the concave and the cylindrical envelope of the rotor which is partially surrounded by the concave arrangement.

Each support arm for example comprises a spacer portion and a base portion, wherein the base portion supports the concave section. The spacer portion separates the adjacent side-by-side concave sections whereas the base portion provides the structural support. The end support arms for example have an “L” profile whereas the central support arm or arms have an inverted “T” profile.

The base portion of each support arm for example comprises a recess and each concave section comprises a radially outwardly projecting roller, wherein the radially outwardly projecting roller is configured to be fully received within an associated recess when the concave section is in the installed position. In this way, a load is removed from the roller once the concave section is installed, and the support for the concave section instead becomes mating surfaces of the framework of the concave section and the support arm. The roller is only providing support during installation or removal of the concave section.

The concave section for example comprises a radially outwardly projecting roller at each lateral side of the concave section. Thus, the opposite lateral sides are supported on the support arms by rollers.

The concave sections for example also comprise comprise a recess and each base portion comprises a radially inwardly projecting roller, wherein the radially inwardly projecting roller is configured to be fully received within an associated recess when the concave section is in the installed position. Again, the load is removed from the roller when it is received in a recess.

By having a pair of rollers along each lateral edge of each concave section, with one fixed to the concave section (facing radially outwardly) and one fixed to the frame (facing radially inwardly) the two rollers remain supporting the concave section almost until it is removed. In particular, the rollers on the concave at at the front end (i.e. the end that is inserted forwards) and the rollers on the frame are at the back end.

The concave section for example comprises a recess at each lateral side of the concave section. Thus, there is again roller support at each side of each concave section. In total, each concave section is supported by four rollers, two attached to the concave section and two attached to the support arms.

Each concave section for example comprises a stop plate at a back face of the concave section, and the stop plate is boltable to the frame when the concave section is in the installed position. This enables the concave sections to be locked in position, from the front of the combine harvester.

Each concave section for example comprises alignment pins at a front face of the concave section, wherein the alignment pins pass through alignment openings of the frame when the concave section is in the installed position. Thus, the front end of the concave section is positionally fixed to the frame, but without needing fixings to be applied.

The concave arrangement for example further comprises sliders between the concave sections and the frame. These can be used to reduce friction instead of having metal parts abutting each other.

This disclosure also provides a threshing system comprising:
the concave arrangement as defined above; and
a threshing rotor, wherein the concave sections are mounted around a portion of the threshing rotor.

The frame for example has an adjustable distance to an axis of rotation of the threshing rotor. This enables concave adjustment (as well as concave replacement).

This disclosure also provides a combine harvester comprising:
a crop cutting head;
the threshing system defined above; and
a grain cleaning system for receiving the cut and threshed crop material.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with this disclosure;

FIG. 2 shows one example of threshing system and grain cleaning apparatus in more detail;

FIG. 3 shows a concave arrangement for a combine harvester;

FIGS. 4 and 5 show views of the concave arrangement with all three concave sections installed;

FIGS. 6 and 7 show views of the concave section in more detail;

FIG. 8 shows a view of the frame;

FIG. 9 shows a side view of a fully inserted concave section; and

FIG. 10 shows an arrangement of a transverse threshing rotor and concave and axial separation system.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure relates to a concave arrangement for a combine harvester that has a frame which supports a set of side-by-side concave sections, each supported by a pair of support arms of the frame. A roller arrangement is provided between each concave section and each of the pair of support arms such that each concave section is slidable around the frame in a generally circumferential direction between installed and retracted positions. The concave sections can be fixed to the frame in their installed positions.

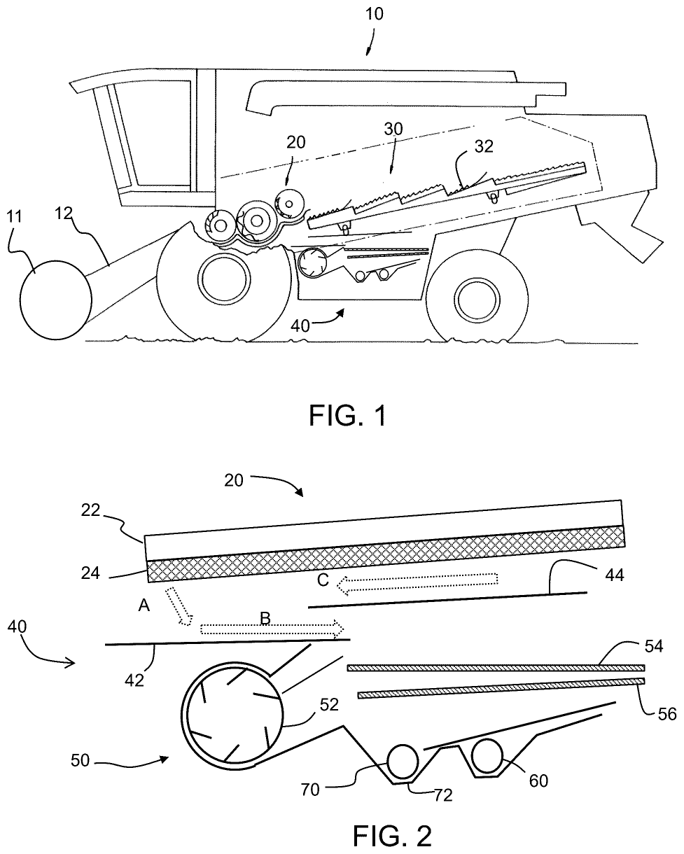

FIG. 1 shows a known combine harvester 10 to which this disclosure may be applied. A crop cutting head 11 (known as the header) for example comprises a wide laterally extending transverse auger, which cuts the crop material and drives it inwardly towards a central area. A front elevator housing 12 receives the cut crop material and includes a feederhouse for transporting the crop material.

The feederhouse delivers the crop material to a threshing system 20 for detaching grains of cereal from the ears of cereal, and a separating apparatus 30 which is connected downstream of the threshing system 20. The threshing system comprises one or more threshing units, in particular rotors, and associated concaves.

In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

In the example shown, the threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e. formed by rotating elements with an axis of rotation in the longitudinal direction (direction of travel). For example, the threshing section may have axially-aligned rasp bars spaced around the front section whilst the separating section has separating elements or fingers arranged in a pattern, e.g. a spiral pattern, extending from the rasp bars to the rear of the rotor.

An axial threshing (and separating) system 20 is shown in FIG. 2, together with a cleaning apparatus 40.

The threshing system 20 comprises an axial rotor 22 beneath which is mounted the concave 24. The concave may have different sections along its length, and the first section to receive the crop material (to the left in FIG. 2) may have a releasable concave, or else the whole length of the concave may be releasable. The separating function involves conveying the crop stream rearwardly in a ribbon passing along a spiral path.

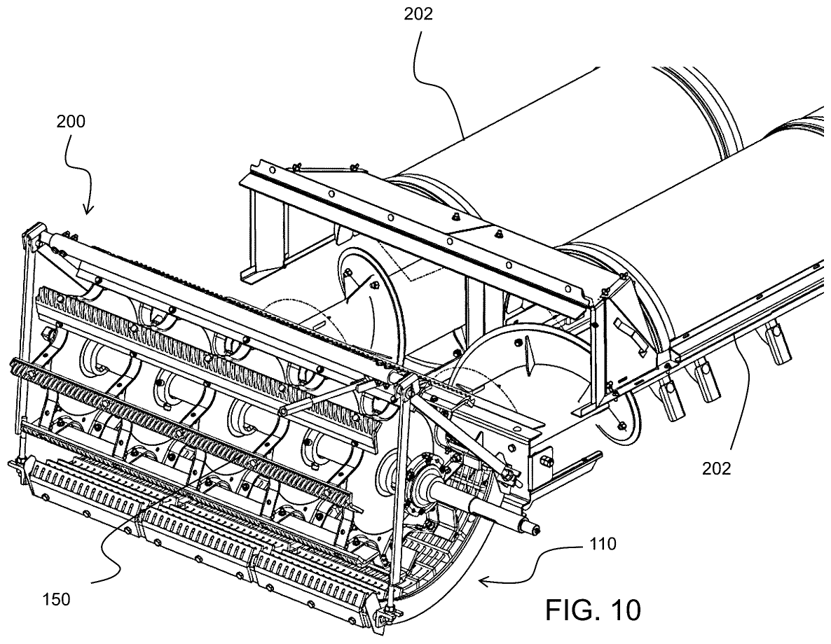

Transverse (conventional) threshing may also be combined with axial separation (as shown in FIG. 10).

The initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the tank.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” when describing the flow of crop material refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to on-board tank (not shown) by grain collecting auger 70 which resides in a transverse trough 70 at the bottom of the grain cleaning unit 50. Tailings blocked by sieve 56 are conveyed rearwardly by the oscillating motion thereof to a rear edge from where the tailings are directed to the returns auger 60 for reprocessing in a known manner.

This disclosure relates to the design of the concave used in the threshing system (or within a separating system). This disclosure may be applied to transverse threshing and/or separating or axial threshing and/or separating.

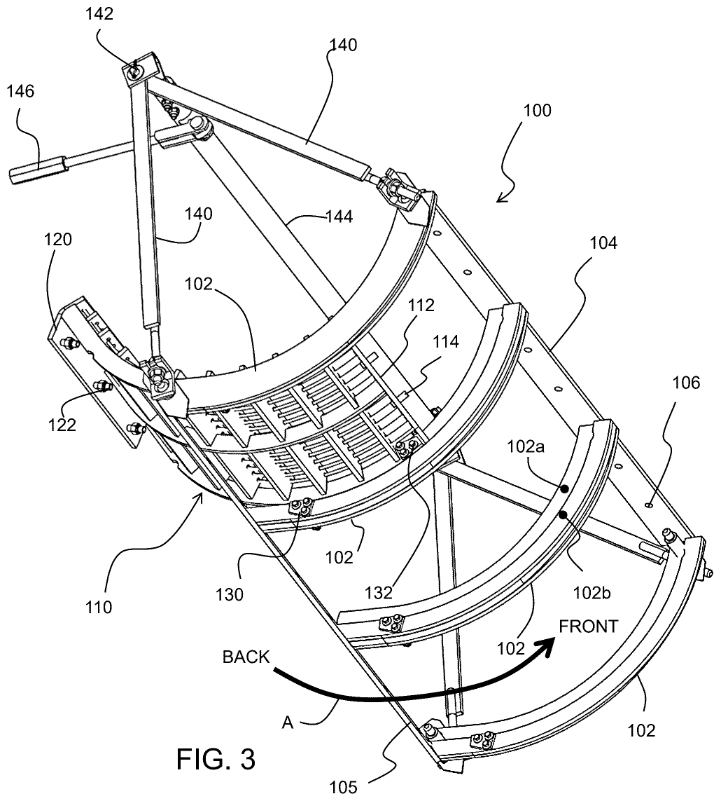

FIG. 3 shows a concave arrangement for a combine harvester. A frame 100 comprises a set of arcuate support arms 102 arranged parallel to each other in a row. Together, they form a cradle for receiving the concave, which, as is well known, is a grid structure of rods.

The support arms 102 each comprise a spacer portion 102a and a base portion 102b. The concave comprises a set of concave portions, one of which 110 is shown in FIG. 3. The concave portion 110 rests on the base portions of the support arms 102 at each lateral side, and the spacer portion forms lateral edges to define a space to be occupied by the concave portion 110. The end support arms for example have an “L” profile whereas the central support arm or arms have an inverted “T” profile.

In order to define the location of parts of the concave and frame, reference will be made to the “front” and “back”. As will be come clear below, the concave is installed in sections and each section is slid into place. This sliding insertion direction will be considered to be a “forward” direction, so that a “front” end is the end which is further in the forward direction compared to a “back” end. Note that with this definition, the front of the concave section and the front of the frame may be towards the back of the combine harvester and the back of the concave section and the back of the frame may be towards the front of the combine harvester.

FIG. 3 represents this insertion direction with arrow A, and it is a generally circumferential direction. Thus, the front of the concave section is the end which is first inserted into the receiving space, and the front of the frame is the end which contacts the front of the concave section when it is fully installed.

The frame comprises a front plate 104 and a back plate 105 which each connect together the support arms.

The concave section also comprises a front plate 112 and a back plate 120. The front plate 112 has projecting pins 114, and these are received by holes 106 in the front plate 104 of the frame. The back plate 120 functions as a stop plate, limiting the insertion of the concave section into the receiving space defined by the frame.

A roller arrangement is provided between each concave section 110 and each of the adjacent pair of support arms 102 supporting that section, such that each concave section 110 is slidable around the frame along an arcuate path between installed and retracted positions, and this sliding is motion involves rolling along the rollers. This arcuate path follows a generally circumferential direction, so that the arcuate path curves around the axis of rotation of the rotor. The path is “generally circumferential” in that there are gaps and clearance between the concave and the threshing cylinder which can result in an arcuate path that is not perfectly circumferential. Also, the beginning of the insertion movement will involve placing the concave section over the rails, and this will not be in a circumferential direction.

At or near the back end of each support arm 102 is a first roller 130 (or a pair of first rollers for the central support arms). At or near the front end of the concave section, on each side, is a second roller 132.

The first rollers 130, mounted on the support arms 102, each comprise a radially inwardly projecting roller so that as the concave section is moved, the roller rolls along the outer surface of side pieces of the concave section.

The second rollers 132, mounted on the concave section 110, each comprise a radially outwardly projecting roller so that as the concave section is moved, the roller rolls along the base portion 102b.

By having one set of rollers fixed to the concave section (at the front) and one set of rollers fixed to the support arms (at the back), the concave section is supported for sliding movement by pairs of rollers along almost the entire range of movement.

FIG. 3 also shows that the frame 100 is suspended from arms 140. The arms connect with an eccentric coupling 142 to a control rod 144, wherein rotation of the control rod 144 by means of an adjustment handle 146 implements an adjustment of the frame (and hence concave) position relative to a rotor received within the frame (not shown in FIG. 3).

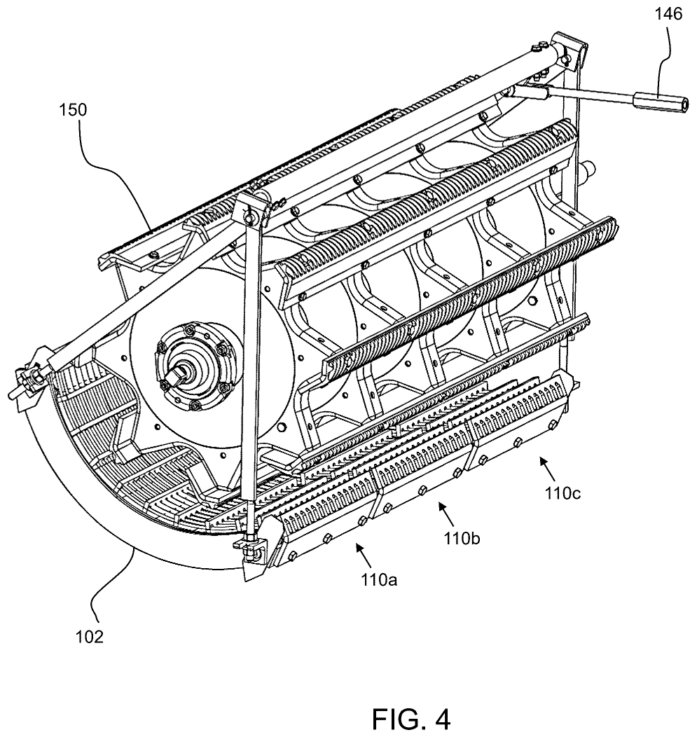

FIG. 4 shows a first view of the concave arrangement with all three concave sections 110a, 110b, 110c installed. It also shows the threshing rotor 150 received in the frame. The use of three concave sections is just an example. There may be only two concave sections or there may be more than three.

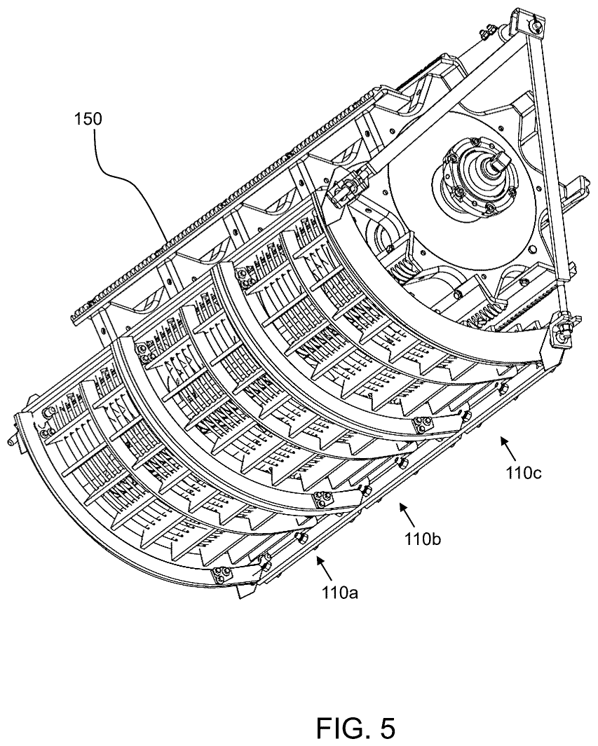

FIG. 5 shows a second view of the concave arrangement with all three concave sections 110a, 110b, 110c installed.

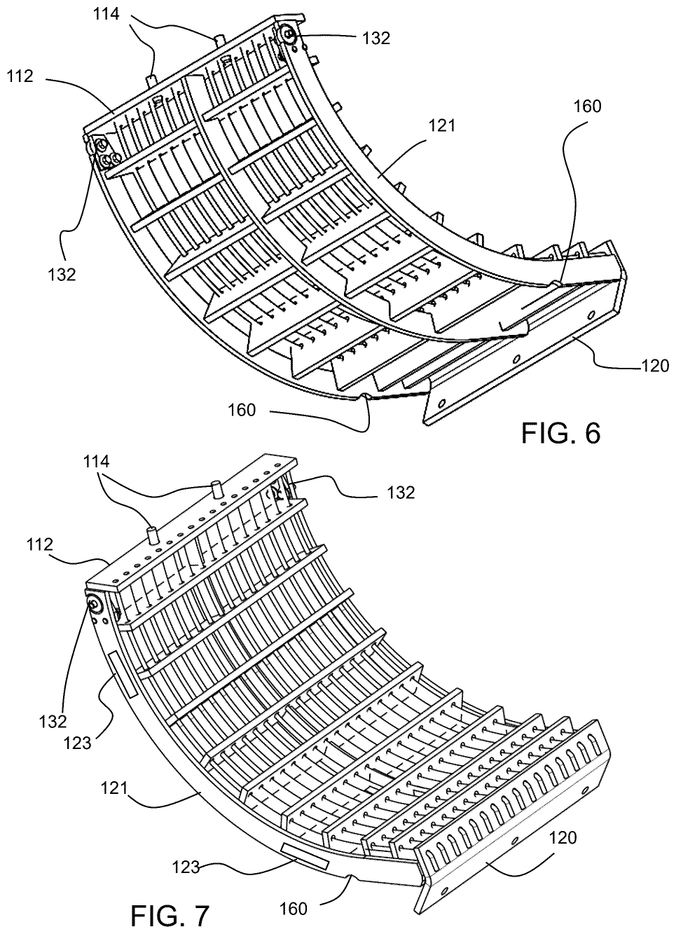

FIGS. 6 and 7 show views of the concave section in more detail. The concave section has side pieces 121 as mentioned above, along which the first rollers 130 roll. Each side piece 121 of the concave section has a recess 160. The recess is on a radially outwardly facing edge. The recess is designed to receive fully the radially inwardly projecting second roller 130 when the concave section is in the installed position. Thus, the recesses 160 are near the back end of the concave section, at a location corresponding to the location of the first rollers 130 when the concave section is installed. In this way, once the concave section is installed, it is no longer supported by the rollers 130. Instead, the side pieces 121 rest against the base portions 102b instead of being raised above the base portions by the rollers. In this way, the load is removed from the first rollers 130 when they are received in a respective recess.

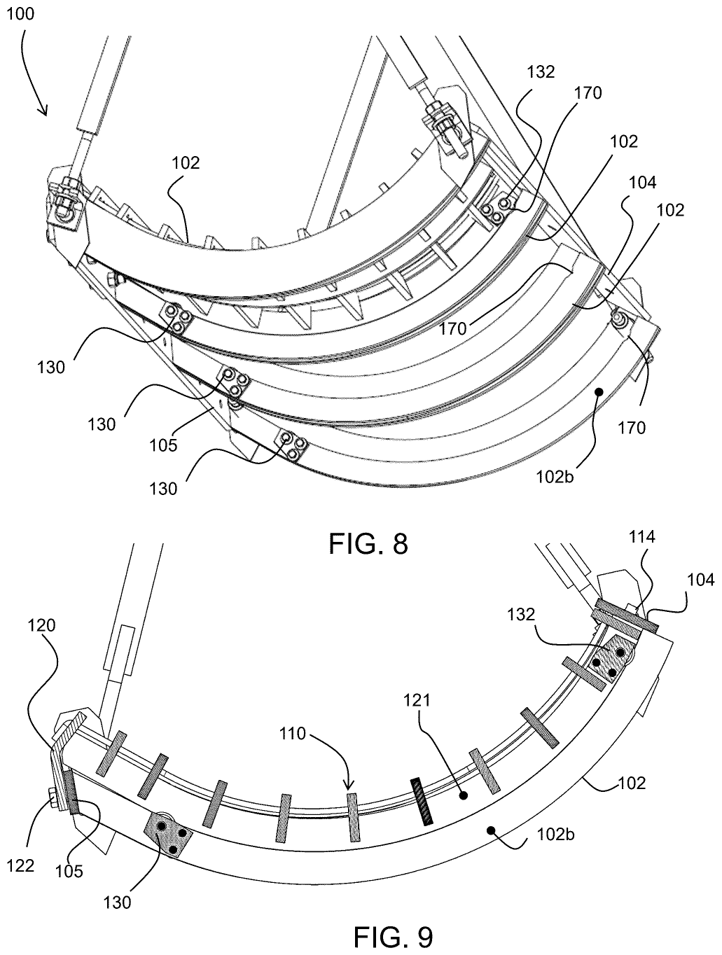

The same concept is applied to the second rollers 132. This can be seen in FIG. 8, which shows a view of the frame 100 in which recesses 170 can be seen provided in the base section 102b. The recess is on a radially inwardly facing edge. The recesses are at the front of the base section, at a location corresponding to the location of the second rollers 132 when the concave sections are installed. In this way, once the concave sections are installed, they are no longer supported by the rollers 132. Instead, the side pieces 121 rest against the base portions 102b and the load is removed from the rollers 132 when they are received in a respective recess.

The concave arrangement may further comprise sliders between the concave sections and the frame. These can be used to reduce friction instead of having metal parts abutting each other. For example, sliders may be fixed to the lateral outer edges of the side pieces 121, as shown in FIG. 7, as regions 123. These prevent metal to metal contact between the side pieces 121 and the spacer portions 102a.

FIG. 9 shows a side view of a fully inserted concave section 110 and shows that the side piece 121 sits directly on the base portion 102b of the support arm 102. This means there is no gap between the parts, so that no debris can accumulate between them. This avoids the movement of the concave sections being blocked during removal. FIG. 9 also shows the bolts 122 which secure the back plate 120 at the back end of the concave section to the frame. The front end of the concave section is held in position by the projecting pins 114. Any suitable fixing may be used for fixing the concave sections to the frame in their installed positions, and the bolts 122 are just one example.

This concave design enables the concave to be swapped over in sections, and each section runs on rollers for easy removal and replacement. The concave sections are inserted and removed along an arcuate path around the axis of curvature of the concave, namely in a generally circumferential direction as explained above.

FIG. 10 shows an arrangement of a transverse threshing rotor 150 and concave 110 and axial separation system comprises two separating augers 202 downstream of the threshing system.

When the concave is used in transverse configuration, access to the concave sections may be from the front of the combine harvester, for example after removing the feederhouse. When the concave is used in an axial configuration, access to the concave sections may be made from the side of the combine harvester.

It is noted that the rollers may be wheels (i.e. with a single rotation axis) but they may also be ball bearings (which freely rotate). Thus, the term “roller” should be understood as any rotational coupling which avoids a sliding frictional contact but allows one surface to roll along the other.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A concave arrangement for a combine harvester, comprising:
a frame comprising at least three arcuate support arms arranged parallel to each other in a row;
a set of at least two concave sections for positioning side-by-side along an axial direction of the concave arrangement, each concave section for positioning between a respective adjacent pair of support arms, supported by those support arms,
wherein the concave arrangement comprises a roller arrangement between each concave section and each of the adjacent pair of support arms such that each concave section is slidable around the frame along an arcuate path between installed and retracted positions,
and wherein the concave arrangement comprises a fixing for fixing the concave sections to the frame in their installed positions.

2. The concave arrangement of claim 1, wherein each support arm comprises a spacer portion and a base portion, wherein the base portion supports the concave section.

3. The concave arrangement of claim 2, wherein the base portion of each support arm comprises a recess and each concave section comprises a radially outwardly projecting roller, wherein the radially outwardly projecting roller is configured to be fully received within an associated recess when the concave section is in the installed position.

4. The concave arrangement of claim 1, wherein the concave section comprises a radially outwardly projecting roller at each lateral side of the concave section.

5. The concave arrangement of claim 1, wherein the concave sections comprise a recess and each base portion comprises a radially inwardly projecting roller, wherein the radially inwardly projecting roller is configured to be fully received within an associated recess when the concave section is in the installed position.

6. The concave arrangement of claim 5, wherein the concave section comprises a recess at each lateral side of the concave section.

7. The concave arrangement of claim 1, wherein each concave section comprises a stop plate at a back face of the concave section, wherein the stop plate is boltable to the frame when the concave section is in the installed position.

8. The concave arrangement of claim 1, wherein the concave section comprises alignment pins at a front face of the concave section, wherein the alignment pins pass through alignment openings of the frame when the concave section is in the installed position.

9. The concave arrangement of claim 1, further comprising sliders between the concave sections and the frame.

10. A threshing system comprising:
the concave arrangement of claim 1; and
a threshing rotor, wherein the concave sections are mounted around a portion of the threshing rotor

11. The threshing system of claim 10, wherein the frame has an adjustable distance to an axis of rotation of the threshing rotor.

12. A combine harvester comprising:
a crop cutting head;
the threshing system of claim 10; and
a grain cleaning system for receiving the cut and threshed crop material.
